(19) United States
(12) Patent Application Publication
(10) Pub. No.: US 2024/0080930 A1
(43) Pub. Date: Mar. 7, 2024

(54) NEW SMALL DATA TRANSMISSION INDICATION

(71) Applicant: QUALCOMM Incorporated, San Diego, CA (US)

(72) Inventors: Ruiming ZHENG, Beijing (CN); Linhai HE, San Diego, CA (US); Ozcan OZTURK, San Diego, CA (US)

(21) Appl. No.: 18/261,815

(22) PCT Filed: Mar. 18, 2022
(86) PCT No.: PCT/CN2022/081617

§ 371 Date: Jul. 17, 2023

(30) Foreign Application Priority Data
Mar. 19, 2021 (WO) PCT/CN2021/081733

(51) Int. Cl. H04W 76/20; H04W 74/08; H04W 76/19

(52) U.S. Cl. CPC H04W 76/20; H04W 74/0833; H04W 76/19

(57) ABSTRACT

Various aspects of the present disclosure generally relate to wireless communication. In some aspects, a user equipment (UE) may detect, while in a radio resource control (RRC) inactive state or an RRC idle state, that data of a small data transmission (SDT) type for a non-SDT data radio bearer (DRB) has entered a buffer of the UE. The UE may transmit a message indicating the data in the buffer for the non-SDT DRB. The message may be associated with a UE ID. Numerous other aspects are described.

### CROSS-REFERENCE TO RELATED APPLICATION

This patent application claims priority to PCT Patent Application No. PCT/CN2021/081733, filed on Mar. 19, 2021, entitled “NEW SMALL DATA TRANSMISSION INDICATION,” which is hereby expressly incorporated by reference herein.

### FIELD OF THE DISCLOSURE

Aspects of the present disclosure relate generally to wireless communication and more specifically to techniques and apparatuses for indicating new small data transmissions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink or “forward link” refers to the communication link from the BS to the UE, and “uplink” or “reverse link” refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes detecting, while in a radio resource control (RRC) inactive state or an RRC idle state, that data of a small data transmission (SDT) type for a non-SDT data radio bearer (DRB) has entered a buffer of the UE. The method may include transmitting a message indicating the data in the buffer for the non-SDT DRB. The message may be associated with a UE identifier (ID), such that the message is a dedicated message.

In some aspects, a method of wireless communication performed by a UE includes detecting, while in an RRC inactive state or an RRC idle state, that new data of an SDT type has entered a buffer of the UE during an SDT subsequent data transmission period. The method may include transmitting, during the SDT subsequent data transmission period, a message indicating the new data in the buffer. The message may be associated with a UE ID.

In some aspects, a method of wireless communication performed by a network entity includes receiving, from a UE during an SDT subsequent data transmission period, a message indicating that new data of an SDT type has entered a buffer of the UE, and receiving the new data. The message may be associated with a UE ID.

In some aspects, a UE for wireless communication includes a memory and one or more processors coupled to the memory, the memory including instructions executable by the one or more processors to cause the UE to detect, while in an RRC inactive state or an RRC idle state, that data of an SDT type for a non-SDT DRB has entered a buffer of the UE, and transmit a message indicating the data in the buffer for the non-SDT DRB.

In some aspects, a UE for wireless communication includes a memory and one or more processors coupled to the memory, the memory including instructions executable by the one or more processors to cause the UE to detect, while in an RRC inactive state or an RRC idle state, that new data of an SDT type has entered a buffer of the UE during an SDT subsequent data transmission period, and transmit, during the SDT subsequent data transmission period, a message indicating the new data in the buffer.

In some aspects, a network entity for wireless communication includes a memory and one or more processors coupled to the memory, the memory including instructions executable by the one or more processors to cause the network entity to receive, from a UE during an SDT subsequent data transmission period, a message indicating that new data of an SDT type has entered a buffer of the UE, and receive the new data.

In some aspects, a non-transitory computer-readable medium stores a set of instructions for wireless communication includes one or more instructions that, when executed by one or more processors of a UE, cause the UE to detect, while in an RRC inactive state or an RRC idle state, that data of an SDT type for a non-SDT DRB has entered a buffer of the UE, and transmit a message indicating the data in the buffer for the non-SDT DRB.

In some aspects, a non-transitory computer-readable medium stores a set of instructions for wireless communication includes one or more instructions that, when executed by one or more processors of a UE, cause the UE to detect, while in an RRC inactive state or an RRC idle state, that new data of an SDT type has entered a buffer of the UE during an SDT subsequent data transmission period, and transmit, during the SDT subsequent data transmission period, a message indicating the new data in the buffer.

In some aspects, a non-transitory computer-readable medium stores a set of instructions for wireless communication includes one or more instructions that, when executed by one or more processors of a network entity, cause the network entity to receive, from a UE during an SDT subsequent data transmission period, a message indicating that new data of an SDT type has entered a buffer of the UE, and receive the new data.

In some aspects, an apparatus for wireless communication includes means for detecting, while in an RRC inactive state or an RRC idle state, that data of an SDT type for a non-SDT DRB has entered a buffer of the UE, and means for transmitting a message indicating the data in the buffer for the non-SDT DRB.

In some aspects, an apparatus for wireless communication includes means for detecting, while in an RRC inactive state or an RRC idle state, that new data of an SDT type has entered a buffer of the UE during an SDT subsequent data transmission period, and means for transmitting, during the SDT subsequent data transmission period, a message indicating the new data in the buffer.

In some aspects, an apparatus for wireless communication includes means for receiving, from a UE during an SDT subsequent data transmission period, a message indicating that new data of an SDT type has entered a buffer of the UE, and means for receiving the new data.

Aspects generally include a method, apparatus, system, computer program product, non-transitory computer-readable medium, user equipment, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 illustrates an example of a wireless network in which a UE may support additional communication modes, in accordance with the present disclosure.

FIG. 4 is a diagram illustrating an example of indicating new data in a buffer that was not empty, in accordance with the present disclosure.

FIG. 5 is a diagram illustrating an example of indicating new data for uplink configured grant (UL-CG), in accordance with the present disclosure.

FIG. 6 is a diagram illustrating an example of indicating new data for a non-small data transmission (SDT) data radio bearer (DRB), in accordance with the present disclosure.

FIG. 7 is a diagram illustrating an example of transmitting new data of the SDT type in a first uplink message, in accordance with the present disclosure.

FIG. 8 is a diagram illustrating an example process performed, for example, by a UE, in accordance with the present disclosure.

FIG. 9 is a diagram illustrating an example process performed, for example, by a UE, in accordance with the present disclosure.

FIG. 10 is a diagram illustrating an example process performed, for example, by a network entity, in accordance with the present disclosure.

FIGS. 11-13 are block diagrams of example apparatuses for wireless communication, in accordance with the present disclosure.

FIG. 14 is a diagram illustrating an example of a disaggregated base station, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

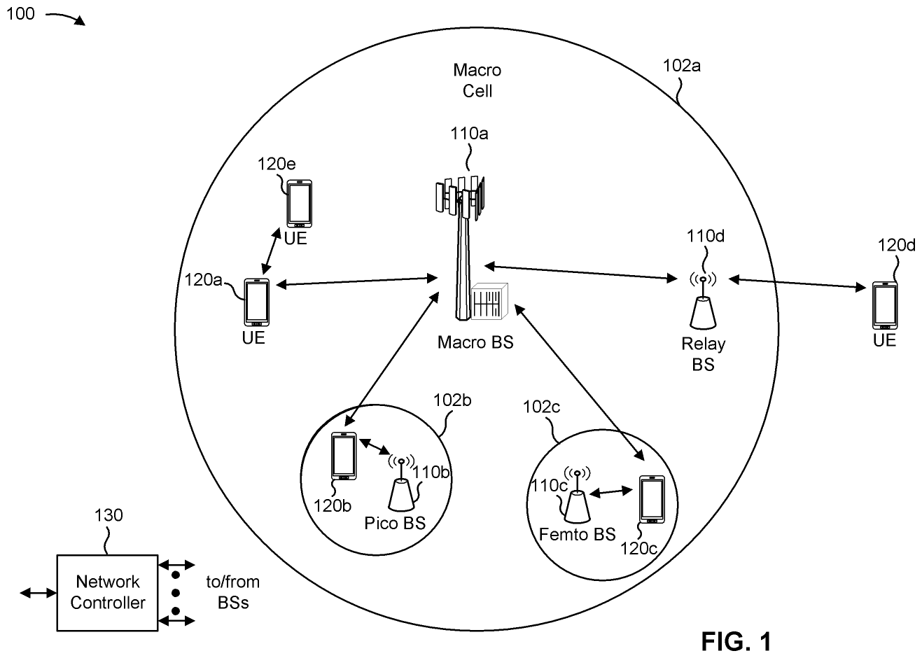

FIG. 1 is a diagram illustrating an example of a wireless network 100, in accordance with the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (MC), or a Non-Real Time (Non-RT) MC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

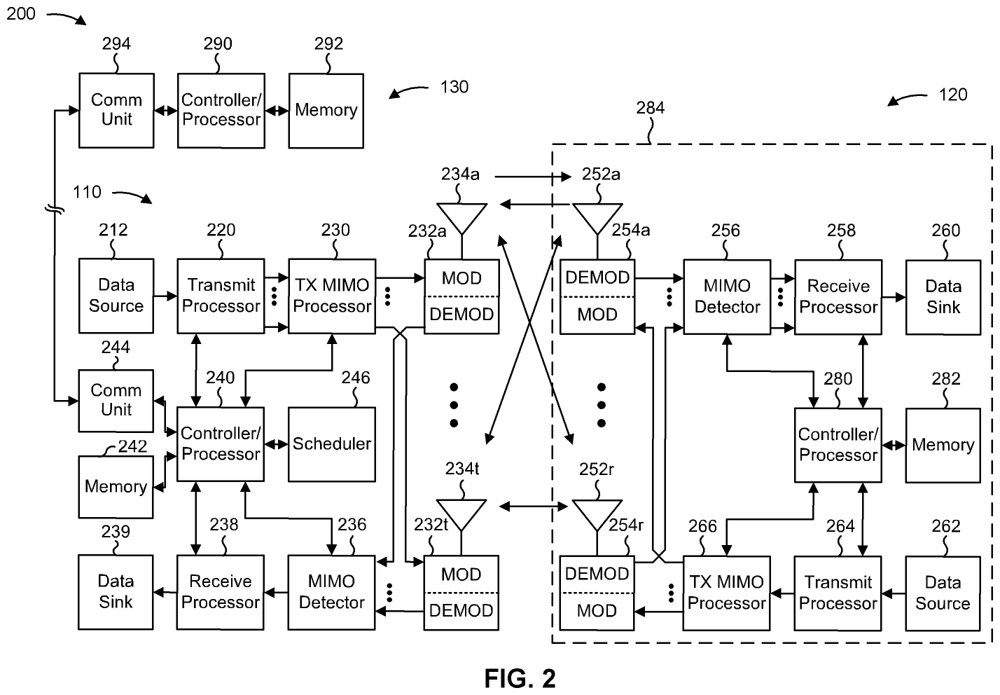

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), CQI, and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

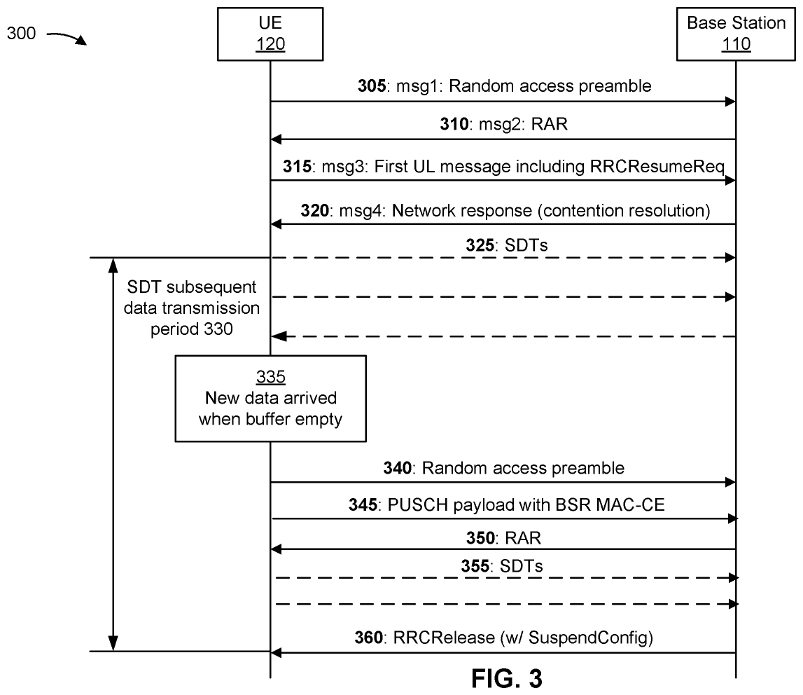

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 3-13).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 3-13).

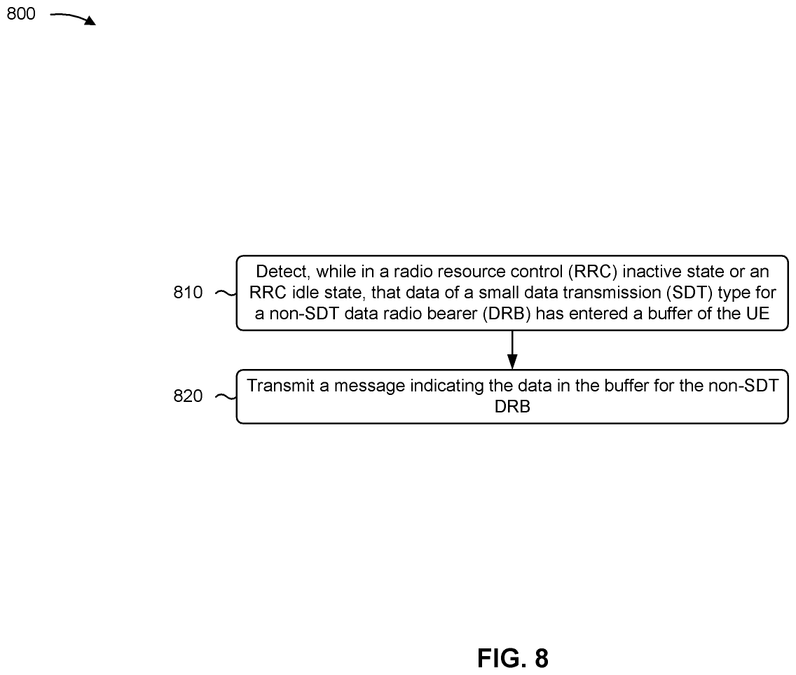

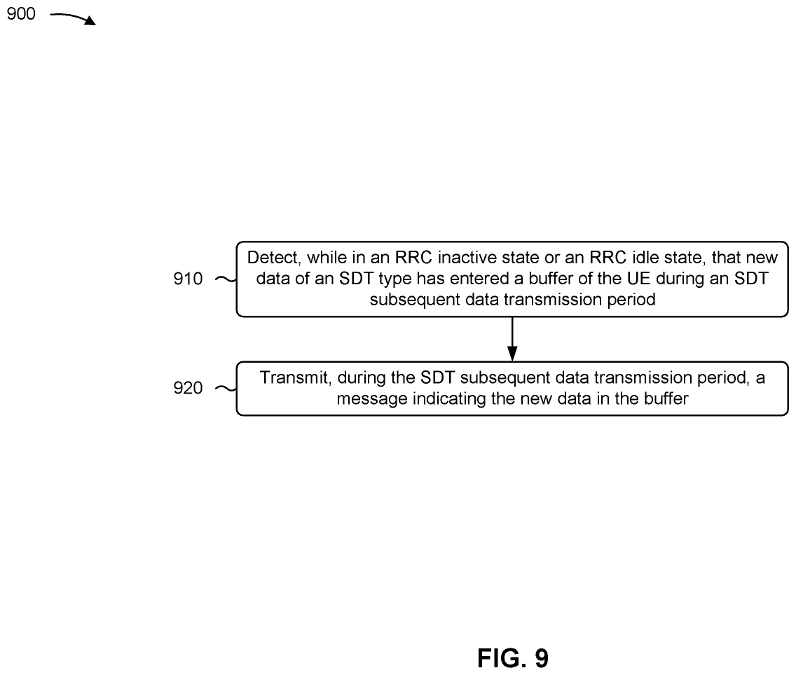

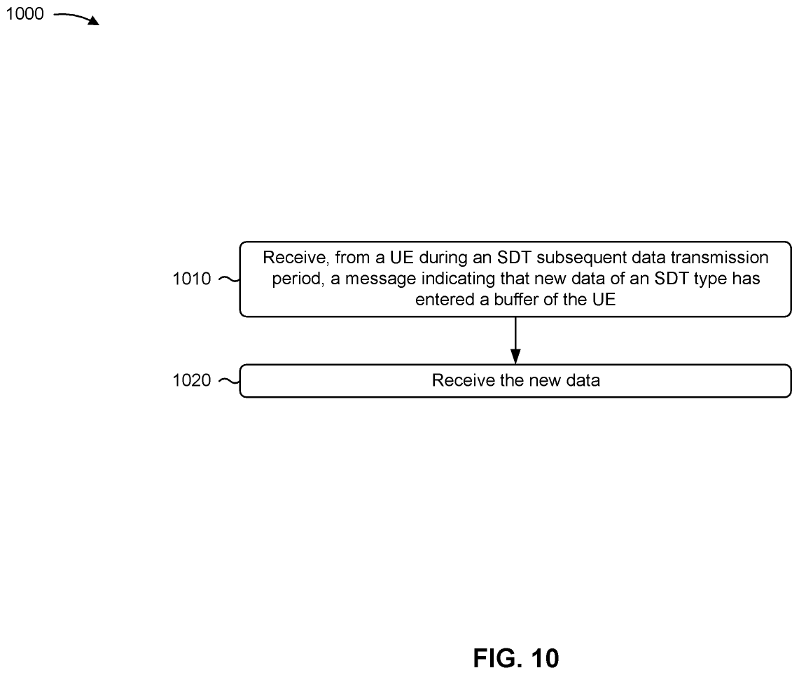

Controller/processor 240 of base station 110, controller/processor 280 of UE 120, and/or any other component(s) of FIG. 2 may perform one or more techniques associated with indicating new small data transmissions (SDTs), as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, process 1000 of FIG. 10, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code) for wireless communication. For example, the one or more instructions, when executed (e.g., directly, or after compiling, converting, interpreting) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, and/or other processes as described herein. In some aspects, executing instructions may include running the instructions, converting the instructions, compiling the instructions, and/or interpreting the instructions.

In some aspects, UE 120 includes means for detecting, while in a radio resource control (RRC) inactive state or an RRC idle state, that data of an SDT type for a non-SDT data radio bearer (DRB) has entered a buffer of the UE, and/or means for transmitting a message indicating the data in the buffer for the non-SDT DRB. The means for UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, UE 120 includes means for detecting, while in an RRC inactive state or an RRC idle state, that new data of an SDT type has entered a buffer of the UE during an SDT subsequent data transmission period, and/or means for transmitting, during the SDT subsequent data transmission period, a message indicating the new data in the buffer. The means for UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, a network entity (e.g., base station 110) includes means for receiving, from a UE during an SDT subsequent data transmission period, a message indicating that new data of an SDT type has entered a buffer of the UE, and/or or means for receiving the new data. The means for base station 110 to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

FIG. 3 is a diagram illustrating an example 300 of indicating new data after a 4-step random access channel (RACH) procedure, in accordance with the present disclosure. As shown in FIG. 3, a network entity (e.g., base station 110) and a UE 120 may communicate with one another to perform the 4-step RACH procedure.

UE 120 may perform a RACH procedure to establish an RRC connection with base station 110. The RACH procedure may involve signaling in 2 steps (2-step RACH procedure) or 4 steps (4-step RACH procedure). As a first step of a 4-step RACH procedure and as shown by reference number 305, UE 120 may transmit a random access message (RAM), which may include a preamble (sometimes referred to as a random access preamble, a physical RACH (PRACH) preamble, or a RAM preamble). The message that includes the preamble may be referred to as a message 1, msg1, MSG1, a first message, or an initial message in a 4-step RACH procedure. The random access message may include a random access preamble identifier.

Base station 110 may receive the RAM preamble transmitted by UE 120. If base station 110 successfully receives and decodes the RAM preamble, base station 110 may then receive and decode the RAM payload. As shown by reference number 310, base station 110 may transmit a random access response (RAR) as a reply to the preamble. The message that includes the RAR may be referred to as message 2, msg2, MSG2, or a second message in a 4-step random access procedure. In some aspects, the RAR may indicate the detected random access preamble identifier (e.g., received from UE 120 in msg1). Additionally, or alternatively, the RAR may indicate a resource allocation to be used by UE 120 to transmit message 3 (msg3).

In some aspects, as part of the second step of the 4-step RACH procedure, the base station 110 may transmit a physical downlink control channel (PDCCH) communication for the RAR. The PDCCH communication may schedule a physical downlink shared channel (PDSCH) communication that includes the RAR. For example, the PDCCH communication may indicate a resource allocation for the PDSCH communication. Also as part of the second step of the 4-step RACH procedure, base station 110 may transmit the PDSCH communication for the RAR, as scheduled by the PDCCH communication.

As shown by reference number 315, UE 120 may transmit an RRC connection request message. The RRC connection request message may be referred to as message 3, msg3, MSG3, or a third message of a 4-step RACH procedure. In some aspects, the RRC connection request may include a UE identifier, uplink control information (UCI), and/or a physical uplink shared channel (PUSCH) communication (e.g., an RRC connection request). UE 120 may transition between different modes based at least in part on various commands and/or communications received from base station 110, and UE 120 may transmit an RRC resume request (RRCResumeRequest) in the msg3 to transition from an RRC inactive state to an RRC active state. The RRC resume request may also establish some security for messages from UE 120 to base station 110, by verifying an identity of UE 120. UE 120 may include data, such as an SDT, in the msg3 with the RRC resume request.

As shown by reference number 320, base station 110 may transmit an RRC connection setup message. The RRC connection setup message may be referred to as message 4, msg4, MSG4, or a fourth message of a 4-step RACH procedure. In some aspects, the RRC connection setup message may include a detected UE identifier, a timing advance value, and/or contention resolution information. In some aspects, if UE 120 performs a 2-step RACH procedure, the msg1 and the msg3 may be combined into a single message that is referred to as a “msgA,” and the msg2 and the msg4 may be combined into a single message that is referred to as a “msgB.”

After completion of the 4-step (or 2-step) RACH procedure, UE 120 may transmit and receive data. However, UE 120 may enter an inactive state, such as an RRC inactive state, to conserve battery power and network resources in times of infrequent data traffic. “Inactive state” may refer to a UE that is operating in an inactive communication mode. To reenter an active state, UE 120 may perform another RACH procedure or another connection establishment procedure. In many applications, UE 120 may generate only a small amount of data in a burst of a data session. Examples of such applications include enhanced mobile broadband (eMBB) communications, IoT communications, instant messaging applications, social media applications, and/or wearable device applications. Reestablishing an RRC connection using a RACH procedure may consume significant resources of UE 120 and base station 110. Therefore, in some scenarios, it may be inefficient to reestablish an RRC connection for a small uplink data transfer. For example, UE 120 and base station 110 may waste processing resources and signaling resources reestablishing an RRC connection solely to transmit a small data burst.

Some RATs may provide a service for transmitting an SDT in an inactive mode, such as via an uplink RACH message or a configured uplink resource (e.g., a dedicated preconfigured uplink resource, a preconfigured uplink resource, a dedicated uplink resource). However, not all small data sizes may fit within an uplink RACH message or a configured uplink resource. Therefore, as shown by reference number 325, UE 120 may transmit data of the SDT type (small data transmitted during the RRC inactive state or the RRC idle state) as part of an SDT subsequent data transmission period 330. SDT subsequent data transmission period 330 may be subsequent to a RACH procedure or a configuration for uplink grants. During the SDT subsequent data transmission period, base station 110 may allow UE 120 to transmit data of the SDT type during an RRC inactive state or an RRC idle state, without requiring UE 120 to enter an RRC connected state or an RRC active state. UE 120 may transmit data of the SDT type during the SDT subsequent data transmission period from the buffer, which holds data of the SDT type. UE 120 may transmit data until the buffer is empty.

If new data enters that buffer during SDT subsequent data transmission period 330, base station 110 may not be aware of the new data if the new data arrived in the buffer after UE 120 has transmitted a buffer status report (BSR) and before UE 120 has received an RRC response message from base station 110. In order to transmit the new data, UE 120 may need base station 110 to provide an uplink grant or scheduled resource. In any event, the behavior for UE 120 is not defined for when new data arrives in the buffer during an SDT subsequent data transmission period. Without such a definition, UE 120 and base station 110 may waste processing resources and signaling resources determining how to handle new data in the buffer during the SDT subsequent data transmission period. In some scenarios, the new data may arrive in the buffer for non-SDT DRBs that are not configured to resume data transmission during the SDT subsequent data transmission period. There is no signaling defined for when new data arrives in the buffer for non-SDT DRBs. As a result, there may be latency that causes UE 120 and base station 110 to consume time and other processing resources and signaling resources.

According to various aspects described herein, as shown by reference number 335, UE 120 may detect that new data of the SDT type has arrived in the buffer. UE 120 may then transmit an indication of the new data in the buffer to base station 110. The indication may include a buffer status in a medium access control control element (MAC-CE) or an RRC message.

If the buffer was empty when the new data arrived, UE 120 may initiate a second RACH procedure if there is no available uplink grant or other scheduled resource for transmitting the new data of the SDT type. UE 120 may be in an RRC inactive or an RRC idle state. In some aspects, the second RACH procedure, to obtain more uplink grants, may involve less signaling or smaller messages than a full RACH procedure. As shown by reference number 340, UE 120 may transmit a random access preamble in the second RACH procedure. As shown by reference number 345, UE 120 may transmit a PUSCH payload or some other data, including the new data of an SDT type, to base station 110. UE 120 may also transmit the indication of the new data in a BSR MAC-CE. As shown by reference number 350, base station 110 may transmit an RAR, and as shown by reference number 355, UE 120 may transmit the new data of the SDT type. In some aspects, UE 120 may wait for a triggering condition (e.g., minimum data in buffer threshold) to transmit the indication. The triggering condition may depend on logical channel priorities. If UE 120 meets the trigger condition to trigger the BSR MAC-CE, the second RACH procedure from reference number 340 to reference number 350 may not be performed. UE 120 may transmit the new data of the SDT type after the BSR MAC-CE is triggered.

As shown by reference number 360, base station 110 may transmit an RRC release message, which may end the SDT subsequent data transmission period. Base station 110 may include a suspension configuration that configured UE 120 to suspend data transmissions and/or to suspend an RRC connection.

If UE 120 already transmitted an RRC resume request message in the first RACH procedure, UE 120 may not be able to transmit a second RRC resume request message. To maintain some type of security for transmission of the new data, UE 120 may transmit a UE identifier (ID) with a RACH message or with the indication of the new data in the buffer in the message shown by reference number 345. The UE ID may include a cell radio network temporary identifier (C-RNTI) (e.g., UE ID scrambled with C-RNTI). Base station 110 may use the UE ID to identify UE 120 and a buffer status of UE 120, in order to verify the new data of the SDT type from UE 120. Base station 110 may keep UE 120 in the RRC inactive state or the RRC idle state for transmitting the new data of the SDT type or may configure UE 120 to transition to an RRC connected state or an RRC active state before transmitting the new data. In some aspects, the message with a UE ID may be a dedicated control message. The UE 120 may transmit the dedicated control message in a resource associated with the UE 120, which may be dedicated for the UE 120.

As indicated above, FIG. 3 is provided as an example. Other examples may differ from what is described with regard to FIG. 3.

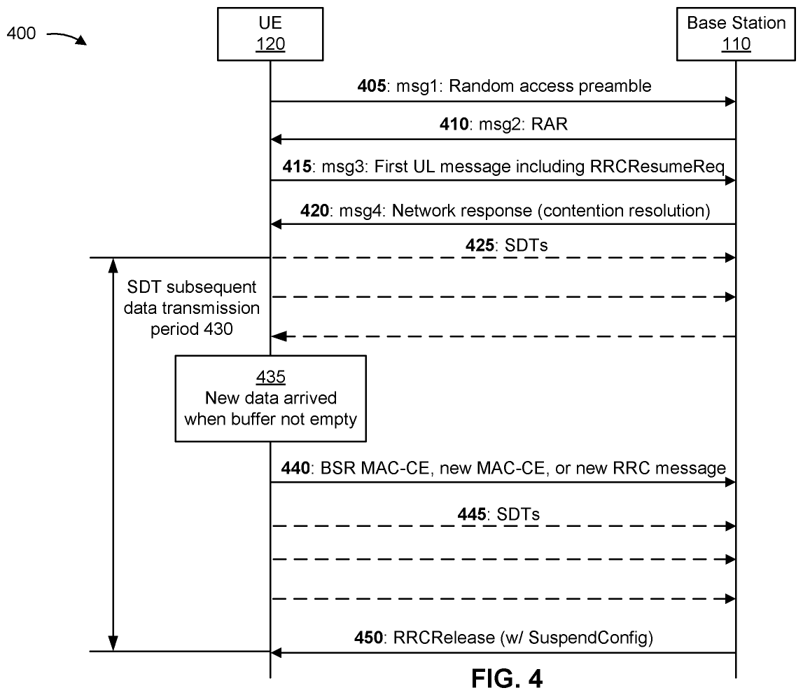

FIG. 4 is a diagram illustrating an example 400 of indicating new data in a buffer that was not empty, in accordance with the present disclosure. As shown in FIG. 4, a base station 110 and a UE 120 may communicate with one another.

Base station 110 and a UE 120 may communicate with one another to perform the 4-step RACH procedure. As shown by reference number 405, UE 120 may transmit msg1. As shown by reference number 410, base station 110 may transmit msg2. As shown by reference number 415, UE 120 may transmit msg3. As shown by reference number 420, base station 110 may transmit msg4. As shown by reference number 425, UE 120 may transmit SDTs as part of an SDT subsequent data transmission period 430.

If the buffer was not empty when the new data entered the buffer, base station 110 may continue to schedule resources for the UE. As shown by reference number 435, if UE 120 detects that the new data arrived in the buffer when the buffer was not empty (if scheduled resources are available), UE 120 may use a scheduled resource for transmitting the new data of the SDT type. As shown by reference number 440, UE 120 may transmit an indication of the new data, without performing a second RACH procedure. The indication may be a BSR MAC-CE, a new MAC-CE, or a new RRC message. The new MAC-CE or RRC message may be able to indicate new data for either an SDT DRB or a non-SDT DRB, or for both an SDT DRB and a non-SDT DRB. The new MAC-CE or RRC message may be considered “new,” because the new MAC-CE or RRC message is not defined by an existing standard or format, and the new MAC-CE or RRC message may be considered a “unified” message, because the new MAC-CE or RRC message may apply to both SDT DRBs and non-SDT DRBs.

As shown by reference number 445, UE 120 may use scheduled resources to transmit the new data as one or more SDTs. Subsequent data transmission period 430 may end when UE 120 receives an RRC release message, as shown by reference number 450.

As indicated above, FIG. 4 is provided as an example. Other examples may differ from what is described with regard to FIG. 4.

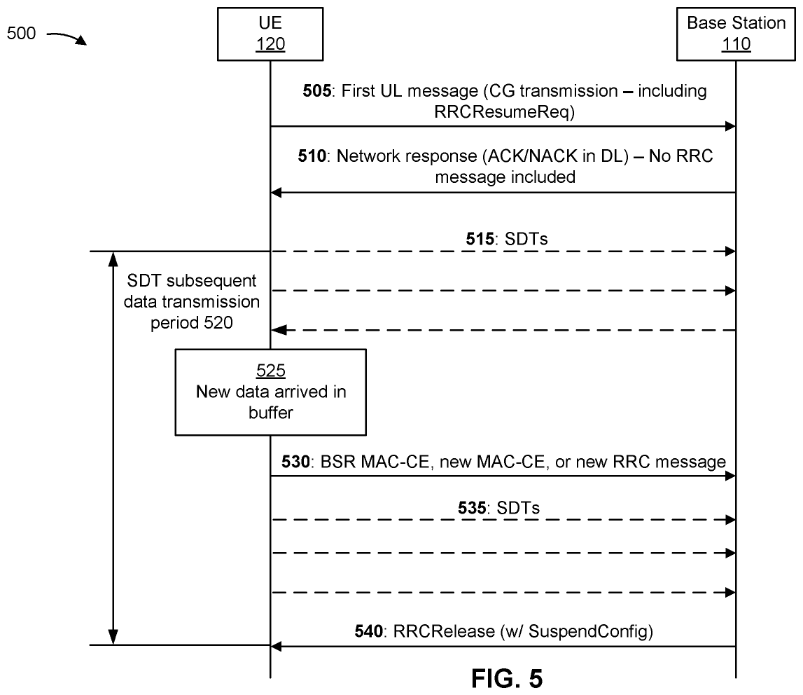

FIG. 5 is a diagram illustrating an example 500 of indicating new data for uplink configured grant (UL-CG), in accordance with the present disclosure. As shown in FIG. 5, a base station 110 and a UE 120 may communicate with one another.

In some aspects, UE 120 may be transmitting uplink data on pre-configured PUSCH resources. For example, UE 120 may be reusing UL-CG type 1. As shown by reference number 505, UE 120 may transmit a first uplink message with a scheduled resource as part of UL-CG. The uplink message may include an RRC resume request. As shown by reference number 510, base station 110 may transmit a response, such as an acknowledgment (ACK) or a negative acknowledgment (NACK). No RRC message may be included. As shown by reference number 515, UE 120 may transmit SDTs as part of an SDT subsequent data transmission period 520.

As shown by reference number 525, UE 120 may detect that there is new data of the SDT type in the buffer. As shown by reference number 530, UE 120 may transmit an indication of the new data in a BSR MAC-CE, a new MAC-CE, or a new RRC message. As shown by reference number 535, UE 120 may transmit the new data in the buffer with scheduled resources. As shown by reference number 540, UE 120 may receive an RRC release message to end SDT subsequent data transmission period 520.

As indicated above, FIG. 5 is provided as an example. Other examples may differ from what is described with regard to FIG. 5.

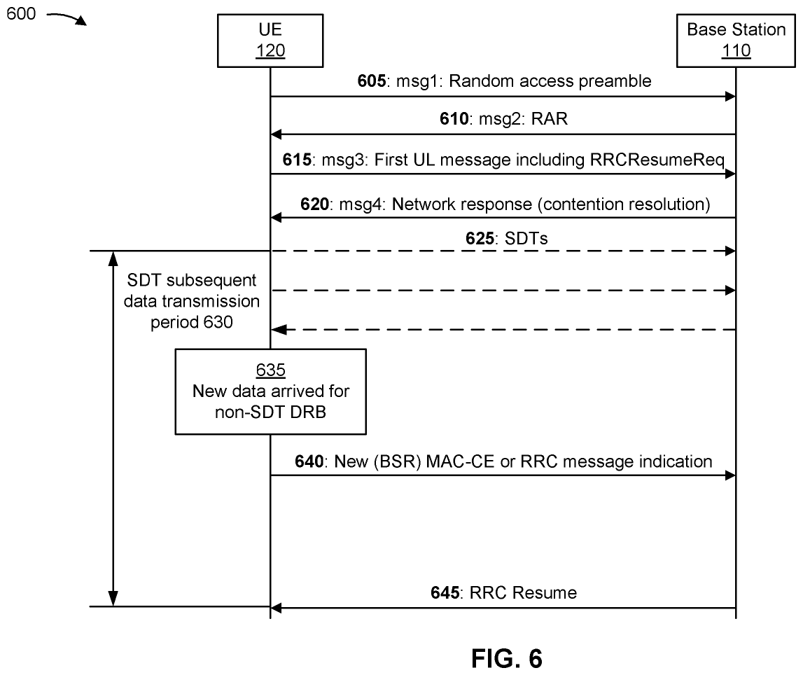

FIG. 6 is a diagram illustrating an example 600 of indicating new data for a non-SDT DRB, in accordance with the present disclosure. As shown in FIG. 6, a base station 110 and a UE 120 may communicate with one another.

In some scenarios, the new data may arrive in the buffer for an SDT DRB, which is a DRB that is configured to resume data transmission (with an RRC resume message) during the SDT subsequent data transmission period. However, if new data arrives for a non-SDT DRB, which is not configured for data of the SDT type and that is not configured to resume data transmission during the SDT subsequent data transmission period, there is no current procedure for notifying base station 110 of the new data for the non-SDT DRB. Base station 110 may not have information as to whether UE 120 is able to transmit data of the SDT type for a non-SDT DRB.

In some aspects, UE 120 may transmit an indication of the new data of the SDT type, even for non-SDT DRBs. While UE 120 may transmit the indication as a buffer status in a MAC-CE for SDT DRBs, UE 120 may transmit the indication in a new MAC-CE message or a new RRC message that is capable of indicating new data for either an SDT DRB or a non-SDT DRB. For example, the new MAC-CE may include a 1-bit indication of whether there is new data for a non-SDT DRB. The new MAC-CE may also include a buffer status for an SDT DRB. The new MAC-CE may indicate a DRB ID or a logical channel group (LCG) ID.

By indicating new data of the SDT type in the buffer with the new MAC-CE (or new RRC message), rather than using an existing BSR MAC-CE for SDT DRBs and a new MAC-CE for non-SDT DRBs, UE 120 may efficiently notify base station 110 of new data in the buffer without using additional signaling resources for separate MAC-CEs. Because UE 120 may transmit the indication of the new data of the SDT type to base station 110, including for non-SDT DRBs, UE 120 and base station 110 may conserve time, processing resources, and signaling resources that would otherwise be consumed by waiting for uplink resources, delaying transmission of the new data, or performing full RACH procedures that are unnecessary.

Example 600 shows part of a RACH procedure involving a non-SDT DRB. As shown by reference number 605, UE 120 may transmit a msg1. As shown by reference number 610, base station 110 may transmit a msg2. As shown by reference number 615, UE 120 may transmit a msg3. As shown by reference number 620, base station 110 may transmit a msg4. As shown by reference number 625, UE 120 may transmit data of the SDT type during an SDT subsequent data transmission period 630.

As shown by reference number 635, UE 120 may detect that new data has arrived in the buffer for a non-SDT DRB. As shown by reference number 640, UE 120 may transmit a new MAC-CE or a new RRC message that is capable of indicating new data for the non-SDT DRB (and new data for an SDT DRB). The new MAC-CE or new RRC message may indicate a buffer status. The RRC message may include a resume cause. It may be inefficient to keep UE 120 in an RRC inactive state if the non-SDT DRB has new data. Base station 110 may determine to transition UE 120 to an RRC connected state. As shown by reference number 645, base station 110 may transmit an RRC resume message. In some aspects, UE 120 may wait for a triggering condition (e.g., minimum data in buffer threshold) to transmit the indication. The triggering condition may depend on logical channel priorities. If UE 120 meets the trigger condition to trigger a BSR MAC-CE, the BSR MAC-CE may contain both the buffer status information for SDT DRBs as well as for non-SDT DRBs. After UE 120 transmits the BSR MAC-CE to base station 110, base station 110 may determine to transition UE 120 to an RRC connected state.

As indicated above, FIG. 6 is provided as an example. Other examples may differ from what is described with regard to FIG. 6.

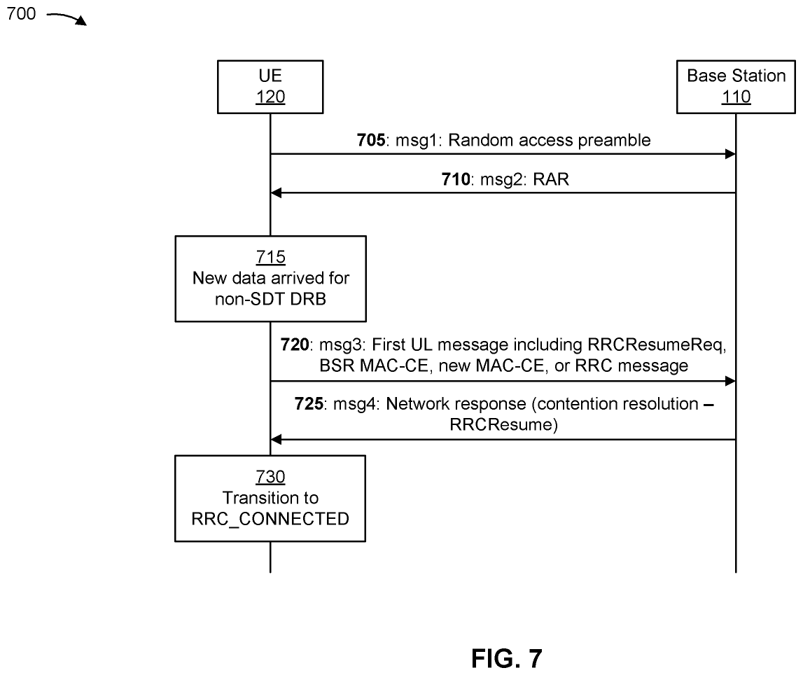

FIG. 7 is a diagram illustrating an example 700 of transmitting new data of the SDT type in a first uplink message, in accordance with the present disclosure. As shown in FIG. 7, a base station 110 and a UE 120 may communicate with one another.

In a first RACH procedure, the first uplink message in a msg3 may include the new data of the SDT type that arrived in the buffer. As shown by reference number 705, UE 120 transmits a msg1. As shown by reference number 710, base station 110 transmits a msg2. As shown by reference number 715, UE 120 may detect that new data of the SDT type has arrived in the buffer. The new data may be for a non-SDT DRB. As shown by reference number 720, UE 120 may transmit the new data of the SDT type as the first uplink message of msg3. The msg3 may include an indication (BSR MAC-CE, new MAC-CE, or RRC message) that there is new data of the SDT type in the buffer. UE 120 may also transmit the RRC resume request message to base station 110. As shown by reference number 725, base station 110 may transmit a msg4, including an RRC resume message. As shown by reference number 730, UE 120 may transition to an RRC connected state after a first uplink data transmission of data that is an SDT type. By transmitting the new data of the SDT type in an earlier RACH message, UE 120 and base station 110 may reduce latency. UE 120 may transmit the new data stored for the non-SDT DRBs after UE 120 transitions to the RRC connected state.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120) performs operations associated with indicating new SDTs.

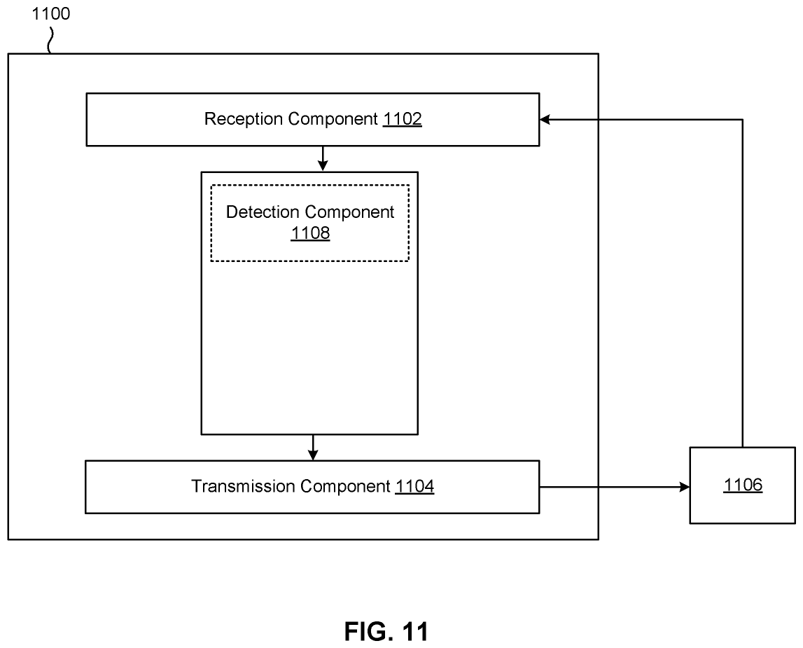

As shown in FIG. 8, in some aspects, process 800 may include detecting, while in an RRC inactive state or an RRC idle state, that data of an SDT type for a non-SDT DRB has entered a buffer of the UE (block 810). For example, the UE (e.g., using detection component 1108 depicted in FIG. 11) may detect, while in an RRC inactive state or an RRC idle state, that data of an SDT type for a non-SDT DRB has entered a buffer of the UE, as described above.

As further shown in FIG. 8, in some aspects, process 800 may include transmitting a message indicating the data in the buffer for the non-SDT DRB (block 820). For example, the UE (e.g., using transmission component 1104 depicted in FIG. 11) may transmit a message indicating the data in the buffer for the non-SDT DRB, as described above. In some aspects, the message may be associated with a UE ID.

Process 800 may include additional aspects, such as any single aspect or any combination of aspects described below and/or in connection with one or more other processes described elsewhere herein.

In a first aspect, the message is configured to indicate one or more of data of the SDT type for the non-SDT DRB, or data of the SDT type for an SDT DRB.

In a second aspect, alone or in combination with the first aspect, the transmitting the message includes transmitting a BSR in a MAC-CE or an RRC message. In some aspects, the RRC message includes a resume cause.

In a third aspect, alone or in combination with one or more of the first and second aspects, the transmitting the message includes transmitting the message if a triggering condition is satisfied.

In a fourth aspect, alone or in combination with one or more of the first through third aspects, the transmitting the message includes transmitting the message during an SDT subsequent data transmission period that occurs subsequent to a first RACH procedure.

In a fifth aspect, alone or in combination with one or more of the first through fourth aspects, process 800 includes, before the transmitting the message and if there is no available uplink grant, transmitting a RACH preamble to initiate a second RACH procedure during the SDT subsequent data transmission period.

In a sixth aspect, alone or in combination with one or more of the first through fifth aspects, the message includes at least the UE ID, and the second RACH procedure is performed without transmitting an RRC resume request message.

In a seventh aspect, alone or in combination with one or more of the first through sixth aspects, the transmitting the message includes transmitting the message in a scheduled resource if the scheduled resource is available for use.

In an eighth aspect, alone or in combination with one or more of the first through seventh aspects, the transmitting the message includes transmitting the message during a configured grant SDT subsequent data transmission period.

In a ninth aspect, alone or in combination with one or more of the first through eighth aspects, process 800 includes transmitting the data after transitioning to an RRC connected state.

In a tenth aspect, alone or in combination with one or more of the first through ninth aspects, process 800 includes transmitting the data in the RRC inactive state or the RRC idle state.

In an eleventh aspect, alone or in combination with one or more of the first through tenth aspects, the transmitting the message includes transmitting the message in a first uplink transmission with data of the SDT type, in coordination with an RRC resume request.

In a twelfth aspect, alone or in combination with one or more of the first through eleventh aspects, process 800 includes indicating that the data is of the SDT type for the non-SDT DRB, of the SDT type for an SDT DRB, or for both the SDT DRB and the non-SDT DRB.

In a thirteenth aspect, alone or in combination with one or more of the first through twelfth aspects, the message includes a radio bearer ID.

In a fourteenth eleventh aspect, alone or in combination with one or more of the first through thirteenth aspects, the message indicates a type of radio bearer.

In a fifteenth aspect, alone or in combination with one or more of the first through fourteenth aspects, the message includes an LCG ID.

In a sixteenth aspect, alone or in combination with one or more of the first through fifteenth aspects, the transmitting the message includes transmitting the message in a resource associated with the LIE ID.

In a seventeenth aspect, alone or in combination with one or more of the first through sixteenth aspects, the UE ID includes a C-RNTI.

In an eighteenth aspect, alone or in combination with one or more of the first through seventeenth aspects, the transmitting the message includes transmitting the message during an SDT subsequent data transmission period that occurs subsequent to a first RACH procedure.

In a nineteenth aspect, alone or in combination with one or more of the first through eighteenth aspects, before the transmitting the message and if there is no available uplink grant, transmitting a RACH preamble to initiate a second RACH procedure during the SDT subsequent data transmission period.

In a twentieth aspect, alone or in combination with one or more of the first through nineteenth aspects, the second RACH procedure is performed without transmitting an RRC resume request message.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with indicating new SDTs.

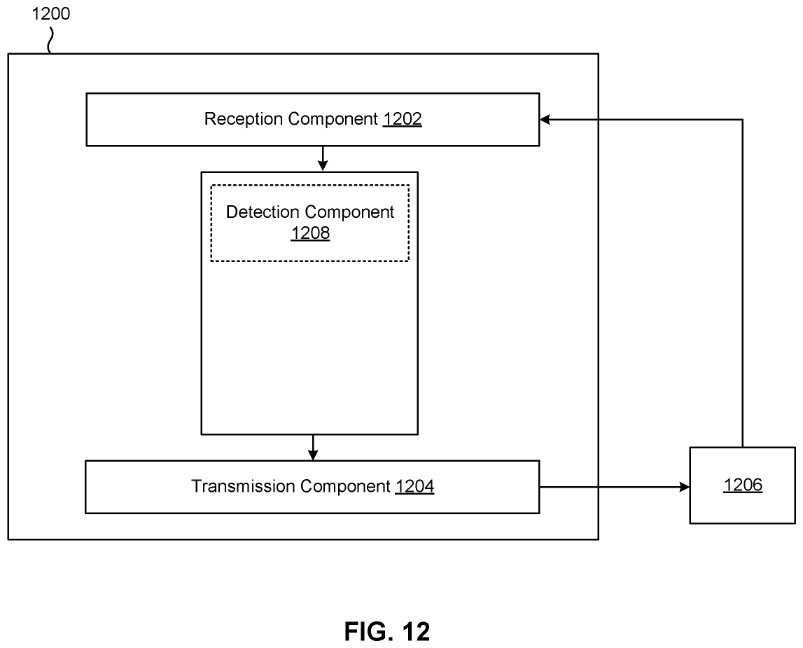

As shown in FIG. 9, in some aspects, process 900 may include detecting, while in an RRC inactive state or an RRC idle state, that new data of an SDT type has entered a buffer of the UE during an SDT subsequent data transmission period (block 910). For example, the UE (e.g., using detection component 1208 depicted in FIG. 12) may detect, while in an RRC inactive state or an RRC idle state, that new data of an SDT type has entered a buffer of the UE during an SDT subsequent data transmission period, as described above.

As further shown in FIG. 9, in some aspects, process 900 may include transmitting, during the SDT subsequent data transmission period, a message indicating the new data in the buffer (block 920). For example, the UE (e.g., using transmission component 1204 depicted in FIG. 12) may transmit, during the SDT subsequent data transmission period, a message indicating the new data in the buffer, as described above. In some aspects, the message may be associated with a UE ID.

Process 900 may include additional aspects, such as any single aspect or any combination of aspects described below and/or in connection with one or more other processes described elsewhere herein.

In a first aspect, the SDT subsequent data transmission period occurs after a first RACH procedure, and process 900 includes, before the transmitting the message and if there is no available uplink grant, transmitting a RACH preamble to initiate a second RACH procedure during the SDT subsequent data transmission period.

In a second aspect, alone or in combination with the first aspect, the message includes at least the UE ID, and the second RACH procedure is performed without transmitting an RRC resume request message.

In a third aspect, alone or in combination with one or more of the first and second aspects, the transmitting the message includes transmitting the message in a scheduled resource if the scheduled resource is available for use.

In a fourth aspect, alone or in combination with one or more of the first through third aspects, the transmitting the message includes transmitting the message during a configured grant SDT subsequent data transmission period.

In a fifth aspect, alone or in combination with one or more of the first through fourth aspects, the transmitting the message includes transmitting a BSR in a MAC-CE or an RRC message. In some aspects, the RRC message includes a resume cause.

In a sixth aspect, alone or in combination with one or more of the first through fifth aspects, the new data is for an SDT DRB.

In a seventh aspect, alone or in combination with one or more of the first through sixth aspects, the new data is for a non-SDT DRB.

In an eighth aspect, alone or in combination with one or more of the first through seventh aspects, the message is configured to indicate one or more of data of the SDT type for a non-SDT DRB, or data of the SDT type for an SDT DRB.

In a ninth aspect, alone or in combination with one or more of the first through eighth aspects, the UE ID includes a C-RNTI.

In a tenth aspect, alone or in combination with one or more of the first through ninth aspects, the SDT subsequent data transmission period occurs after a first RACH procedure, and process 900 includes, before the transmitting the message and if there is no available uplink grant, transmitting a RACH preamble to initiate a second RACH procedure during the SDT subsequent data transmission period.

In an eleventh aspect, alone or in combination with one or more of the first through tenth aspects, the second RACH procedure is performed without transmitting an RRC resume request message.

In a twelfth aspect, alone or in combination with one or more of the first through eleventh aspects, transmitting the message includes transmitting the message during a configured grant SDT subsequent data transmission period.

In a thirteenth aspect, alone or in combination with one or more of the first through twelfth aspects, the message includes a radio bearer ID or indicates a type of radio bearer.

In a fourteenth eleventh aspect, alone or in combination with one or more of the first through thirteenth aspects, the message includes an LCG ID.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., base station 110) performs operations associated with indicating new SDTs.

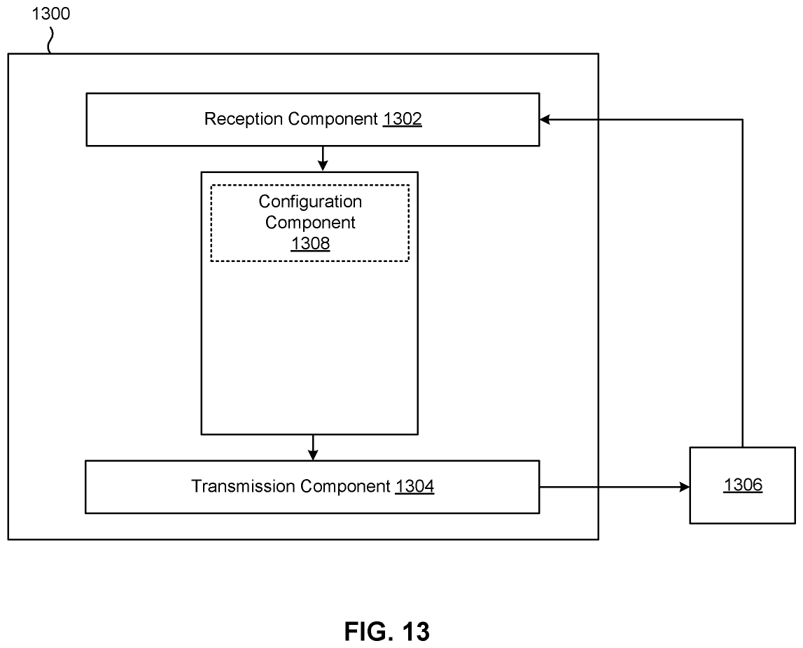

As shown in FIG. 10, in some aspects, process 1000 may include receiving, from a UE during an SDT subsequent data transmission period, a message indicating that new data of an SDT type has entered a buffer of the UE (block 1010). For example, the network entity (e.g., using reception component 1302 depicted in FIG. 13) may receive, from a UE during an SDT subsequent data transmission period, a message indicating that new data of an SDT type has entered a buffer of the UE, as described above. In some aspects, the message may be associated with a UE ID.

As further shown in FIG. 10, in some aspects, process 1000 may include receiving the new data (block 1020). For example, the network entity (e.g., using reception component 1302 depicted in FIG. 13) may receive the new data, as described above.

Process 1000 may include additional aspects, such as any single aspect or any combination of aspects described below and/or in connection with one or more other processes described elsewhere herein.

In a first aspect, the message is configured to indicate one or more of data of the SDT type for a non-SDT DRB, or data of the SDT type for an SDT DRB.

In a second aspect, alone or in combination with the first aspect, the SDT subsequent data transmission period occurs subsequent to a first RACH procedure, and process 1000 includes receiving a preamble to initiate a second RACH procedure during the SDT subsequent data transmission period, where the message includes at least a UE identifier corresponding to the UE, and transmitting an RAR.

In a third aspect, alone or in combination with one or more of the first and second aspects, process 1000 includes transmitting a scheduled resource for the message, and receiving the message in the scheduled resource.

In a fourth aspect, alone or in combination with one or more of the first through third aspects, the message is received in a MAC-CE or an RRC message.

In a fifth aspect, alone or in combination with one or more of the first through fourth aspects, the message includes a BSR.

In a sixth aspect, alone or in combination with one or more of the first through fifth aspects, the message indicates that the new data is for a non-SDT DRB.

In a seventh aspect, alone or in combination with one or more of the first through sixth aspects, process 1000 includes configuring the UE to transmit the new data after transitioning to an RRC connected state.

In an eighth aspect, alone or in combination with one or more of the first through seventh aspects, process 1000 includes configuring the UE to transmit the new data in an RRC inactive state or an RRC idle state.

In a ninth aspect, alone or in combination with one or more of the first through eighth aspects, the UE ID includes a C-RNTI.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a block diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, network entity, or another wireless communication device) using the reception component 1102 and the transmission component 1104. As further shown, the apparatus 1100 may include a detection component 1108, among other examples.

In some aspects, the apparatus 1100 may be configured to perform one or more operations described herein in connection with FIGS. 1-7. Additionally, or alternatively, the apparatus 1100 may be configured to perform one or more processes described herein, such as process 800 of FIG. 8. In some aspects, the apparatus 1100 and/or one or more components shown in FIG. 11 may include one or more components of the UE described above in connection with FIG. 2. Additionally, or alternatively, one or more components shown in FIG. 11 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a demodulator, a MIMO detector, a receive processor, a controller/processor, a memory, or a combination thereof, of the UE described above in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modulator, a transmit MIMO processor, a transmit processor, a controller/processor, a memory, or a combination thereof, of the UE described above in connection with FIG. 2. In some aspects, the transmission component 1104 may be co-located with the reception component 1102 in a transceiver.

The detection component 1108 may detect, while in an RRC inactive state or an RRC idle state, that data of an SDT type for a non-SDT DRB has entered a buffer of the UE. The transmission component 1104 may transmit a message indicating the data in the buffer for the non-SDT DRB. The transmission component 1104 may transmit the data after transitioning to an RRC connected state. The transmission component 1104 may transmit the data in the RRC inactive state or the RRC idle state.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a block diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, network entity, or another wireless communication device) using the reception component 1202 and the transmission component 1204. As further shown, the apparatus 1200 may include a detection component 1208, among other examples.

In some aspects, the apparatus 1200 may be configured to perform one or more operations described herein in connection with FIGS. 1-7. Additionally, or alternatively, the apparatus 1200 may be configured to perform one or more processes described herein, such as process 900 of FIG. 9. In some aspects, the apparatus 1200 and/or one or more components shown in FIG. 12 may include one or more components of the UE described above in connection with FIG. 2. Additionally, or alternatively, one or more components shown in FIG. 12 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a demodulator, a MIMO detector, a receive processor, a controller/processor, a memory, or a combination thereof, of the UE described above in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the UE described above in connection with FIG. 2. In some aspects, the transmission component 1204 may be co-located with the reception component 1202 in a transceiver.

The detection component 1208 may detect, while in an RRC inactive state or an RRC idle state, that new data of an SDT type has entered a buffer of the UE during an SDT subsequent data transmission period. The transmission component 1204 may transmit, during the SDT subsequent data transmission period, a message indicating the new data in the buffer.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a block diagram of an example apparatus 1300 for wireless communication. The apparatus 1300 may be a network entity, or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, network entity, or another wireless communication device) using the reception component 1302 and the transmission component 1304. As further shown, the apparatus 1300 may include a configuration component 1308, among other examples.

In some aspects, the apparatus 1300 may be configured to perform one or more operations described herein in connection with FIGS. 1-7. Additionally, or alternatively, the apparatus 1300 may be configured to perform one or more processes described herein, such as process 1000 of FIG. 10. In some aspects, the apparatus 1300 and/or one or more components shown in FIG. 13 may include one or more components of the base station described above in connection with FIG. 2. Additionally, or alternatively, one or more components shown in FIG. 13 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a demodulator, a MIMO detector, a receive processor, a controller/processor, a memory, or a combination thereof, of the base station described above in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modulator, a transmit MIMO processor, a transmit processor, a controller/processor, a memory, or a combination thereof, of the base station described above in connection with FIG. 2. In some aspects, the transmission component 1304 may be co-located with the reception component 1302 in a transceiver.

The reception component 1302 may receive, from a UE during an SDT subsequent data transmission period, a message indicating that new data of an SDT type has entered a buffer of the UE. The reception component 1302 may receive the new data.

The transmission component 1304 may transmit a scheduled resource for the message. The reception component 1302 may receive the message in the scheduled resource.

The configuration component 1308 may configure the UE to transmit the new data after transitioning to a radio resource control connected state. The configuration component 1308 may configure the UE to transmit the new data in an RRC inactive state or an RRC idle state.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

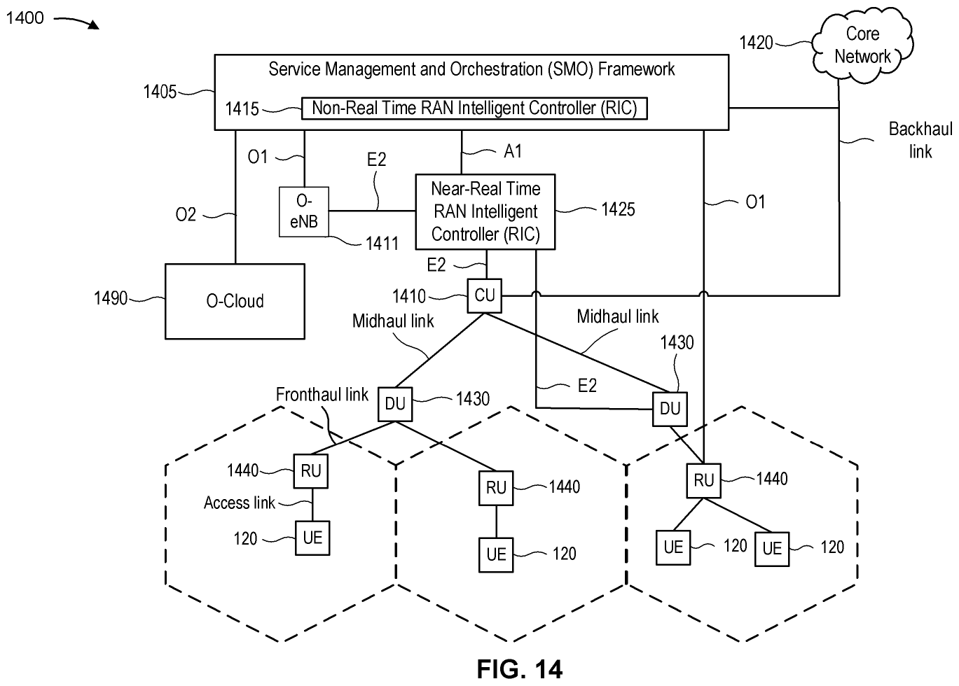

FIG. 14 is a diagram illustrating an example of a disaggregated base station 1400, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station (network entity).

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 1400 architecture may include one or more CUs 1410 that can communicate directly with a core network 1420 via a backhaul link, or indirectly with the core network 1420 through one or more disaggregated base station units (such as a Near-RT RIC 1425 via an E2 link, or a Non-RT RIC 1415 associated with a Service Management and Orchestration (SMO) Framework 1405, or both). A CU 1410 may communicate with one or more DUs 1430 via respective midhaul links, such as an F1 interface. The DUs 1430 may communicate with one or more RUs 1440 via respective fronthaul links. The fronthaul link, the midhaul link, and the backhaul link may be generally referred to as “communication links.” The RUs 1440 may communicate with respective UEs 120 via one or more radio frequency (RF) access links. In some aspects, the UE 120 may be simultaneously served by multiple RUs 1440. The DUs 1430 and the RUs 1440 may also be referred to as “0-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUs 1410, the DUs 1430, the RUs 1440, as well as the Near-RT RICs 1425, the Non-RT RICs 1415 and the SMO Framework 1405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 1410 may host one or more higher layer control functions. Such control functions can include RRC, packet data convergence protocol (PDCP), service data adaptation protocol (SDAP), or the like. Each control function can be implemented with an interface configured to communicate signals with other control functions hosted by the CU 1410. The CU 1410 may be configured to handle user plane functionality (i.e., Central Unit—User Plane (CU-UP)), control plane functionality (i.e., Central Unit—Control Plane (CU-CP)), or a combination thereof. In some implementations, the CU 1410 can be logically split into one or more CU-UP units and one or more CU-CP units. The CU-UP unit can communicate bidirectionally with the CU-CP unit via an interface, such as the E1 interface when implemented in an O-RAN configuration. The CU 1410 can be implemented to communicate with the DU 1430, as necessary, for network control and signaling.

The DU 1430 may correspond to a logical unit that includes one or more base station functions to control the operation of one or more RUs 1440. In some aspects, the DU 1430 may host one or more of a radio link control (RLC) layer, a MAC layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 1430 may further host one or more low PHY layers. Each layer (or module) can be implemented with an interface configured to communicate signals with other layers (and modules) hosted by the DU 1430, or with the control functions hosted by the CU 1410.

Lower-layer functionality can be implemented by one or more RUs 1440. In some deployments, an RU 1440, controlled by a DU 1430, may correspond to a logical node that hosts RF processing functions, or low-PHY layer functions (such as performing fast Fourier transform (FFT), inverse FFT (iFFT), digital beamforming, PRACH extraction and filtering, or the like), or both, based at least in part on the functional split, such as a lower layer functional split. In such an architecture, the RU(s) 1440 can be implemented to handle over the air (OTA) communication with one or more UEs 120. In some implementations, real-time and non-real-time aspects of control and user plane communication with the RU(s) 1440 can be controlled by the corresponding DU 1430. In some scenarios, this configuration can enable the DU(s) 1430 and the CU 1410 to be implemented in a cloud-based RAN architecture, such as a vRAN architecture.

The SMO Framework 1405 may be configured to support RAN deployment and provisioning of non-virtualized and virtualized network elements. For non-virtualized network elements, the SMO Framework 1405 may be configured to support the deployment of dedicated physical resources for RAN coverage requirements which may be managed via an operations and maintenance interface (such as an O1 interface). For virtualized network elements, the SMO Framework 1405 may be configured to interact with a cloud computing platform (such as an open cloud (O-Cloud) 1490) to perform network element life cycle management (such as to instantiate virtualized network elements) via a cloud computing platform interface (such as an O2 interface). Such virtualized network elements can include, but are not limited to, CUs 1410, DUs 1430, RUs 1440 and Near-RT RICs 1425. In some implementations, the SMO Framework 1405 can communicate with a hardware aspect of a 4G RAN, such as an open eNB (O-eNB) 1411, via an O1 interface. Additionally, in some implementations, the SMO Framework 1405 can communicate directly with one or more RUs 1440 via an O1 interface. The SMO Framework 1405 also may include a Non-RT RIC 1415 configured to support functionality of the SMO Framework 1405.

The Non-RT RIC 1415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1425. The Non-RT RIC 1415 may be coupled to or communicate with (such as via an A1 interface) the Near-RT RIC 1425. The Near-RT RIC 1425 may be configured to include a logical function that enables near-real-time control and optimization of RAN elements and resources via data collection and actions over an interface (such as via an E2 interface) connecting one or more CUs 1410, one or more DUs 1430, or both, as well as an O-eNB, with the Near-RT RIC 1425.

In some implementations, to generate AI/ML models to be deployed in the Near-RT RIC 1425, the Non-RT RIC 1415 may receive parameters or external enrichment information from external servers. Such information may be utilized by the Near-RT RIC 1425 and may be received at the SMO Framework 1405 or the Non-RT RIC 1415 from non-network data sources or from network functions. In some examples, the Non-RT RIC 1415 or the Near-RT RIC 1425 may be configured to tune RAN behavior or performance. For example, the Non-RT RIC 1415 may monitor long-term trends and patterns for performance and employ AI/ML, models to perform corrective actions through the SMO Framework 1405 (such as reconfiguration via O1) or via creation of RAN management policies (such as A1 policies).

As indicated above, FIG. 14 is provided as an example. Other examples may differ from what is described with regard to FIG. 14.

The foregoing disclosure provides illustration and description, but is not intended to be exhaustive or to limit the aspects to the precise form disclosed. Modifications and variations may be made in light of the above disclosure or may be acquired from practice of the aspects.

The following provides an overview of some Aspects of the present disclosure:
Aspect 1: A method of wireless communication performed by a user equipment (UE), comprising: detecting, while in a radio resource control (RRC) inactive state or an RRC idle state, that data of a small data transmission (SDT) type for a non-SDT data radio bearer (DRB) has entered a buffer of the UE; and transmitting a message indicating the data in the buffer for the non-SDT DRB.
Aspect 2: The method of Aspect 1, wherein the message is configured to indicate one or more of data of the SDT type for the non-SDT DRB, or data of the SDT type for an SDT DRB.
Aspect 3: The method of Aspect 1 or 2, wherein the transmitting the message includes transmitting a buffer status report in a medium access control control element (MAC-CE) or an RRC message.
Aspect 4: The method of any of Aspects 1-3, wherein the transmitting the message includes transmitting the message if a triggering condition is satisfied.
Aspect 5: The method of any of Aspects 1-4, wherein the transmitting the message includes transmitting the message during an SDT subsequent data transmission period that occurs subsequent to a first random access channel (RACH) procedure.
Aspect 6: The method of Aspect 5, further comprising, before the transmitting the message and if there is no available uplink grant, transmitting a RACH preamble to initiate a second RACH procedure during the SDT subsequent data transmission period.
Aspect 7: The method of Aspect 6, wherein the message includes at least a UE identifier, and the second RACH procedure is performed without transmitting an RRC resume request message.
Aspect 8: The method of any of Aspects 1-7, wherein the transmitting the message includes transmitting the message in a scheduled resource if the scheduled resource is available for use.
Aspect 9: The method of any of Aspects 1-4, wherein the transmitting the message includes transmitting the message during a configured grant SDT subsequent data transmission period.
Aspect 10: The method of any of Aspects 1-9, further comprising transmitting the data after transitioning to an RRC connected state.
Aspect 11: The method of any of Aspects 1-10, further comprising transmitting the data in the RRC inactive state or the RRC idle state.
Aspect 12: The method of any of Aspects 1-4, wherein the transmitting the message includes transmitting the message in a first uplink transmission with data of the SDT type, in coordination with an RRC resume request.
Aspect 13: A method of wireless communication performed by a user equipment (UE), comprising: detecting, while in a radio resource control (RRC) inactive state or an RRC idle state, that new data of a small data transmission (SDT) type has entered a buffer of the UE during an SDT subsequent data transmission period; and transmitting, during the SDT subsequent data transmission period, a message indicating the new data in the buffer.
Aspect 14: The method of Aspect 13, wherein the SDT subsequent data transmission period occurs after a first random access channel (RACH) procedure, and wherein the method further comprises, before the transmitting the message and if there is no available uplink grant, transmitting a RACH preamble to initiate a second RACH procedure during the SDT subsequent data transmission period.
Aspect 15: The method of Aspect 14, wherein the message includes at least a UE identifier, and the second RACH procedure is performed without transmitting an RRC resume request message.
Aspect 16: The method of any of Aspects 13-15, wherein the transmitting the message includes transmitting the message in a scheduled resource if the scheduled resource is available for use.
Aspect 17: The method of Aspect 13, wherein the transmitting the message includes transmitting the message during a configured grant SDT subsequent data transmission period.
Aspect 18: The method of any of Aspects 13-17, wherein the transmitting the message includes transmitting a buffer status report in a medium access control control element (MAC-CE) or an RRC message.
Aspect 19: The method of any of Aspects 13-18, wherein the new data is for an SDT data radio bearer.
Aspect 20: The method of any of Aspects 13-18, wherein the new data is for a non-SDT data radio bearer (DRB).
Aspect 21: The method of any of Aspects 13-20, wherein the message is configured to indicate one or more of data of the SDT type for a non-SDT data radio bearer (DRB), or data of the SDT type for an SDT DRB.
Aspect 22: A method of wireless communication performed by a network entity, comprising: receiving, from a user equipment (UE) during a small data transmission (SDT) subsequent data transmission period, a message indicating that new data of an SDT type has entered a buffer of the UE; and receiving the new data.
Aspect 23: The method of Aspect 22, wherein the message is configured to indicate one or more of data of the SDT type for a non-SDT data radio bearer (DRB), or data of the SDT type for an SDT DRB.
Aspect 24: The method of Aspect 22 or 23, wherein the SDT subsequent data transmission period occurs subsequent to a first random access channel (RACH) procedure, and wherein the method further comprises: receiving a preamble to initiate a second RACH procedure during the SDT subsequent data transmission period, wherein the message includes at least a UE identifier corresponding to the UE; and transmitting a random access response.
Aspect 25: The method of any of Aspects 22-24, further comprising: transmitting a scheduled resource for the message; and receiving the message in the scheduled resource.
Aspect 26: The method of any of Aspects 22-25, wherein the message is received in a medium access control control element (MAC-CE) or a radio resource control message.
Aspect 27: The method of Aspect 26, wherein the message includes a buffer status report.
Aspect 28: The method of any of Aspects 22-27, wherein the message indicates that the new data is for a non-SDT data radio bearer (DRB).
Aspect 29: The method of any of Aspects 22-28, further comprising configuring the UE to transmit the new data after transitioning to a radio resource control connected state.
Aspect 30: The method of any of Aspects 22-29, further comprising configuring the UE to transmit the new data in a radio resource control (RRC) inactive state or an RRC idle state.
Aspect 31: A method of wireless communication performed by a user equipment (UE), comprising: detecting, while in a radio resource control (RRC) inactive state or an RRC idle state, that data of a small data transmission (SDT) type for a non-SDT data radio bearer (DRB) has entered a buffer of the UE; and transmitting a message indicating the data in the buffer for the non-SDT DRB, wherein the message is associated with a UE identifier (ID).
Aspect 32: The method of Aspect 31, further comprising indicating that the data is of the SDT type for the non-SDT DRB, of the SDT type for an SDT DRB, or for both the SDT DRB and the non-SDT DRB.
Aspect 33: The method of Aspect 31 or 32, wherein the transmitting the message includes transmitting a buffer status report in a medium access control control element (MAC-CE) or an RRC message.
Aspect 34: The method of Aspect 33, wherein the RRC message includes a resume cause.
Aspect 35: The method of Aspect 33, wherein the transmitting the message includes transmitting the message if a triggering condition is satisfied.
Aspect 36: The method of any of Aspects 31-35, wherein the message includes a radio bearer identifier.
Aspect 37: The method of any of Aspects 31-36, wherein the message indicates a type of radio bearer.
Aspect 38: The method of any of Aspects 31-37, wherein the message includes a logical channel group identifier.
Aspect 39: The method of any of Aspects 31-38, wherein the transmitting the message comprises transmitting the message in a resource associated with the UE ID.
Aspect 40: The method of any of Aspects 31-39, wherein the UE ID include a cell radio temporary network identifier.
Aspect 41: The method of Aspect 40, wherein the transmitting the message includes transmitting the message during an SDT subsequent data transmission period that occurs subsequent to a first random access channel (RACH) procedure.
Aspect 42: The method of Aspect 40 or 41, further comprising, before the transmitting the message and if there is no available uplink grant, transmitting a RACH preamble to initiate a second RACH procedure during the SDT subsequent data transmission period.
Aspect 43: The method of Aspect 42, wherein the message includes at least the UE ID, and wherein the second RACH procedure is performed without transmitting an RRC resume request message.
Aspect 44: The method of any of Aspects 31-43, wherein the transmitting the message includes transmitting the message in a scheduled resource if the scheduled resource is available for use.
Aspect 45: The method of any of Aspects 31-44, wherein the transmitting the message includes transmitting the message during a configured grant SDT subsequent data transmission period.
Aspect 46: The method of any of Aspects 31-45, further comprising transmitting the data after transitioning to an RRC connected state.
Aspect 47: The method of any of Aspects 31-46, further comprising transmitting the data in the RRC inactive state or the RRC idle state.
Aspect 48: The method of any of Aspects 31-47, wherein the transmitting the message includes transmitting the message in a first uplink transmission with data of the SDT type, in coordination with an RRC resume request.
Aspect 49: A method of wireless communication performed by a user equipment (UE), comprising: detecting, while in a radio resource control (RRC) inactive state or an RRC idle state, that new data of a small data transmission (SDT) type has entered a buffer of the UE during an SDT subsequent data transmission period; and transmitting, during the SDT subsequent data transmission period, a message indicating the new data in the buffer, wherein the message is associated with a UE identifier (ID).
Aspect 50: The method of Aspect 49, wherein the UE identifier includes a cell radio temporary network identifier.
Aspect 51: The method of Aspect 50, wherein the SDT subsequent data transmission period occurs after a first random access channel (RACH) procedure, and wherein the method further comprises, before the transmitting the message and if there is no available uplink grant, transmitting a RACH preamble to initiate a second RACH procedure during the SDT subsequent data transmission period.
Aspect 52: The method of Aspect 51, wherein the message includes at least the UE ID, and wherein the second RACH procedure is performed without transmitting an RRC resume request message.
Aspect 53: The method of any of Aspects 49-52, wherein the transmitting the message includes transmitting the message during a configured grant SDT subsequent data transmission period.
Aspect 54: The method of any of Aspects 49-53, wherein the message includes a radio bearer identifier or indicates a type of radio bearer.
Aspect 55: The method of any of Aspects 49-54, further comprising transmitting a buffer status report in a medium access control control element (MAC-CE) or an RRC message.
Aspect 56: The method of Aspect 55, wherein the RRC message includes a resume cause.
Aspect 57: The method of any of Aspects 49-56, wherein the message includes a logical channel group identifier.
Aspect 58: A method of wireless communication performed by a network entity, comprising: receiving, from a user equipment (UE) during a small data transmission (SDT) subsequent data transmission period, a message indicating that new data of an SDT type has entered a buffer of the UE, wherein the message is associated with a UE ID; and receiving the new data.
Aspect 59: The method of Aspect 58, wherein the UE ID includes a cell radio temporary network identifier.
Aspect 60: The method of Aspect 58 or 59, wherein the message is received in a medium access control control element (MAC-CE) or a radio resource control message.
Aspect 61: An apparatus for wireless communication at a device, comprising a processor; memory coupled with the processor; and instructions stored in the memory and executable by the processor to cause the apparatus to perform the method of one or more of Aspects 1-60.
Aspect 62: A device for wireless communication, comprising memory, and one or more processors coupled to the memory, the memory comprising instructions executable by the one or more processors to cause the device to perform the method of one or more of Aspects 1-60.
Aspect 63: A device for wireless communication, comprising a memory and one or more processors coupled to the memory, the one or more processors configured to perform the method of one or more of Aspects 1-60.
Aspect 64: An apparatus for wireless communication, comprising at least one means for performing the method of one or more of Aspects 1-60.
Aspect 65: A non-transitory computer-readable medium storing code for wireless communication, the code comprising instructions executable by a processor to perform the method of one or more of Aspects 1-60.
Aspect 66: A non-transitory computer-readable medium storing a set of instructions for wireless communication, the set of instructions comprising one or more instructions that, when executed by one or more processors of a device, cause the device to perform the method of one or more of Aspects 1-60.

As used herein, the term “component” is intended to be broadly construed as hardware and/or a combination of hardware and software. Software shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, software, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
memory; and
one or more processors coupled to the memory, the memory comprising instructions executable by the one or more processors to cause the UE to:
detect, while in a radio resource control (RRC) inactive state or an RRC idle state, that data of a small data transmission (SDT) type for a non-SDT data radio bearer (DRB) has entered a buffer of the UE; and
transmit a message indicating the data in the buffer for the non-SDT DRB, wherein the message is associated with a UE identifier (ID).

2. The UE of claim 1, wherein the message is configured to indicate that the data is of the SDT type for the non-SDT DRB, of the SDT type for an SDT DRB, or for both the SDT DRB and the non-SDT DRB.

3. The UE of claim 1, wherein the memory further comprises instructions executable by the one or more processors to cause the UE to transmit a buffer status report in a medium access control control element (MAC-CE) or an RRC message.

4. The UE of claim 3, wherein the memory further comprises instructions executable by the one or more processors to cause the UE to transmit the message if a triggering condition is satisfied.

5. The UE of claim 4, wherein the RRC message includes a resume cause.

6. The UE of claim 1, wherein the message includes a radio bearer identifier.

7. The UE of claim 1, wherein the message indicates a type of radio bearer.

8. The UE of claim 1, wherein the message includes a logical channel group identifier.

9. The UE of claim 8, wherein the memory further comprises instructions executable by the one or more processors to cause the UE to transmit the message in a resource associated with the UE ID.

10. The UE of claim 1, wherein the UE ID include a cell radio temporary network identifier.

11. The UE of claim 10, wherein the memory further comprises instructions executable by the one or more processors to cause the UE to transmit the message during an SDT subsequent data transmission period that occurs subsequent to a first random access channel (RACH) procedure.

12. The UE of claim 11, wherein the memory further comprises instructions executable by the one or more processors to cause the UE to, before the transmitting the message and if there is no available uplink grant, transmit a RACH preamble to initiate a second RACH procedure during the SDT subsequent data transmission period.

13. The UE of claim 12, wherein the message includes at least the UE ID, and the second RACH procedure is performed without transmitting an RRC resume request message.

14. The UE of claim 1, wherein the memory further comprises instructions executable by the one or more processors to cause the UE to transmit the message in a scheduled resource if the scheduled resource is available for use.

15. The UE of claim 1, wherein the memory further comprises instructions executable by the one or more processors to cause the UE to transmit the message during a configured grant SDT subsequent data transmission period.

16. The UE of claim 1, wherein the memory further comprises instructions executable by the one or more processors to cause the UE to transmit the data after transitioning to an RRC connected state.

17. The UE of claim 1, wherein the memory further comprises instructions executable by the one or more processors to cause the UE to transmit the data in the RRC inactive state or the RRC idle state.

18. The UE of claim 1, wherein the memory further comprises instructions executable by the one or more processors to cause the UE to transmit the message in a first uplink transmission with data of the SDT type, in coordination with an RRC resume request.

19. A user equipment (UE) for wireless communication, comprising:
memory; and
one or more processors coupled to the memory, the memory comprising instructions executable by the one or more processors to cause the UE to:
detect, while in a radio resource control (RRC) inactive state or an RRC idle state, that new data of a small data transmission (SDT) type has entered a buffer of the UE during an SDT subsequent data transmission period; and
transmit, during the SDT subsequent data transmission period, a message indicating the new data in the buffer, wherein the message is associated with a UE identifier (ID).

20. The UE of claim 19, wherein the UE ID includes a cell radio temporary network identifier.

21. The UE of claim 19, wherein the SDT subsequent data transmission period occurs after a first random access channel (RACH) procedure, and wherein the memory further comprises instructions executable by the one or more processors to cause the UE to, before the transmitting the message and if there is no available uplink grant, transmit a RACH preamble to initiate a second RACH procedure during the SDT subsequent data transmission period.

22. The UE of claim 21, wherein the message includes at least the UE ID, and the second RACH procedure is performed without transmitting an RRC resume request message.

23. The UE of claim 19, wherein the memory further comprises instructions executable by the one or more processors to cause the UE to transmit the message during a configured grant SDT subsequent data transmission period.

24. The UE of claim 19, wherein the memory further comprises instructions executable by the one or more processors to cause the UE to transmit a buffer status report in a medium access control control element (MAC-CE) or an RRC message.

25. The UE of claim 24, wherein the RRC message includes a resume cause.

26. The UE of claim 19, wherein the message includes a radio bearer identifier or indicates a type of radio bearer.

27. The UE of claim 19, wherein the message includes a logical channel group identifier.

28. A network entity for wireless communication, comprising:
memory; and
one or more processors coupled to the memory, the memory comprising instructions executable by the one or more processors to cause the network entity to:
receive, from a user equipment (UE) during a small data transmission (SDT) subsequent data transmission period, a message indicating that new data of an SDT type has entered a buffer of the UE, wherein the message is associated with a UE identifier (ID); and
receive the new data.

29. The network entity of claim 28, wherein the UE ID includes a cell radio temporary network identifier.

30. The network entity of claim 28, wherein the message is received in a medium access control control element (MAC-CE) or a radio resource control message.
